(19) United States
(12) Patent Application Publication
(10) Pub. No.: US 2025/0139930 A1
(43) Pub. Date: May 1, 2025

(54) METHOD AND DEVICE FOR SHORELINE SEGMENTATION IN COMPLEX ENVIRONMENTS BASED ON THE PERSPECTIVE OF AN UNMANNED SURFACE VESSEL (USV)

(71) Applicant: Hunan University, Changsha (CN)

(72) Inventors: Yunze HE, Changsha (CN); Yong YIN, Changsha (CN); Yiming NA, Changsha (CN); Baoyuan DENG, Changsha (CN)

(21) Appl. No.: 19/007,082

(22) Filed: Dec. 31, 2024

(30) Foreign Application Priority Data
Jan. 3, 2024 (CN) 202410006216.2

(51) Int. Cl. G06V 10/26; B63B 35/00; B63B 43/18; G01S 17/89; G05D 1/622; G05D 107/00; G05D 109/30; G05D 111/10; G06T 7/11; G06V 10/77; G06V 10/80; G06V 10/82; G06V 20/56

(52) U.S. Cl. CPC G06V 10/26; B63B 43/18; G01S 17/89; G05D 1/622; G06T 7/11; G06V 10/7715; G06V 10/806; G06V 10/82; G06V 20/56; B63B 2035/007; G05D 2107/27; G05D 2109/34; G05D 2111/17; G06T 2207/10028; G06T 2207/10048; G06T 2207/20081; G06T 2207/20084; G06T 2207/30252

(57) ABSTRACT

A method for shoreline segmentation in complex environments based on the perspective of an unmanned surface vessel is provided. A visible light image, a thermal infrared image and a raw radar echo image of a shoreline are obtained. The visible light image and the thermal infrared image are subjected to fusion and feasible region segmentation to obtain an all-weather two-dimensional image information of the shoreline, and an echo image including tiny features is obtained based on the raw radar echo image. An extraction region is constrained and shoreline features are enhanced based on the all-weather two-dimensional image information and the echo image to obtain a multi-feature point cloud dataset for shoreline segmentation.

### CROSS-REFERENCE TO RELATED APPLICATIONS

This application claims the benefit of priority from Chinese Patent Application No. 202410006216.2, filed on Jan. 3, 2024. The content of the aforementioned application, including any intervening amendments made thereto, is incorporated herein by reference in its entirety.

### TECHNICAL FIELD

This application relates to shoreline segmentation, and more particularly to a method and device for shoreline segmentation in complex environments based on the perspective of an unmanned surface vessel (USV).

### BACKGROUND

There is a lack of an unmanned surface vessel (USV)-based shoreline recognition and segmentation system suitable for dynamic and complex aquatic environments in the prior art. Current systems mainly focus on the recognition in static environments, without fully considering the environmental diversity and the self-control of USV. Furthermore, these systems generally rely on the data from a single sensor, require high lighting conditions, and cannot achieve all-weather real-time recognition. Due to the size constraints of the USVs and the limitation of the computational power of relevant equipment, it is difficult to apply high-performance models for the practical inspection, thereby hindering further development.

Chinese Patent Application No. 202211018479.2, titled “Method for constructing water surface environment map based on millimeter wave radar”, employs a millimeter wave radar and visible light images to extract shoreline information. However, this method does not involve the vessel's self-control, and fails to completely extract the shoreline depth features. Moreover, this method has poor robustness due to reliance on single visible light images.

Chinese Patent Application No. 201410764435.3, titled “Shoreline registration method based on radar images and electronic chart information”, discloses a shoreline registration method based on radar images and electronic chart information, in which radar charts are processed and registered with accurate electronic charts to achieve the precise shoreline extraction. However, it does not address the shoreline extraction in the absence of accurate charts, and does not involve the vessel self-control.

Chinese Patent Application No. 202310790874.0, titled “Multi-sensor situation awareness and collision avoidance decision-making method for unmanned surface vessels”, designs a collision avoidance perception system for the unmanned surface vessel based on visible light images and radar, and adopts the artificial potential field method for path planning. However, this method has poor robustness when the visible light images are captured in complex environments, and serious deficiencies of single radar features, Moreover, the artificial potential field method fails to adapt to rapidly changing complex environments.

Chinese Patent Application No. 202010717418.X, titled “Unmanned surface vessel path planning method based on deep reinforcement learning and marine environmental elements”, designs a deep reinforcement learning path planning algorithm related to marine factors, but does not involve the multi-source perception to the environment, nor does it provide a self-control scheme for the vessel.

The USV control can be achieved through the separation of longitudinal and steering motions in combination with adaptive control and an adaptive line-of-sight (LOS) guidance algorithm for trajectory tracking (M. Faramin, R. H. Goudarzi, A. Maleki, Track-keeping Observer-based Robust Adaptive Control of an Unmanned Surface Vessel by Applying a 4-DOF Maneuvering Model, Ocean Engineering, Volume 183, 2019, Pages 11-23). Although this method is relatively robust, it does not reserve interfaces for other tasks, and has weak scalability, and poor adaptability to complex situations.

### SUMMARY

In view of the problems in the prior art, this application provides a method and device for shoreline segmentation in complex environments based on the perspective of an unmanned surface vessel.

The present disclosure provides a method for shoreline segmentation in complex environments based on the perspective of an unmanned surface vessel, comprising:
(S1) obtaining a visible light image, a thermal infrared image and a raw radar echo image of a shoreline;
(S2) subjecting the visible light image and the thermal infrared image to fusion and feasible region segmentation to obtain an all-weather two-dimensional image information of the shoreline; and obtaining an echo image of the shoreline based on the raw radar echo image, wherein the echo image comprises a tiny feature with a characteristic signal intensity less than three times a background noise; and
(S3) constraining an extraction region and enhancing shoreline features based on the all-weather two-dimensional image information and the echo image to obtain a multi-feature point cloud dataset for shoreline segmentation.

In an embodiment, the fusion and feasible region segmentation are performed by using a dual modal segmentation network (DMSNet), wherein the DMSNet comprises an encoder, a decoder, and a dual-path feature spatial adaptation (DPFSA) module; and
the fusion and feasible region segmentation are performed through steps of:
extracting, by the encoder, a visible light feature and a thermal infrared feature from the visible light image and the thermal infrared image, respectively;
performing upsampling, by the decoder, on the visible light feature and the thermal infrared feature to obtain an upsampled visible light feature and an upsampled thermal infrared feature;
performing spatial feature extraction, by the DPFSA module, on the upsampled visible light feature and the upsampled thermal infrared feature to obtain a transformed thermal infrared feature and a transformed visible light feature;
fusing, by the DPFSA module, the transformed thermal infrared feature with the transformed visible light feature to obtain a fused feature; and
adding, by the DPFSA module, the fused feature with a previous fused feature point by point to obtain a dual-path feature as the all-weather two-dimensional image information;
wherein for a first set of data, a fused feature from a thermal infrared feature and a visible light feature of the first set of data is used as an initial fused feature.

In an embodiment, the step of obtaining the echo image based on the raw radar echo image comprises:
(S21) obtaining the raw radar echo image by a short-wave pulse radar;
(S22) removing, by a median filter, an anomaly and an artifact from the raw radar echo image to obtain an original shoreline feature; and
(S23) parameterizing the original shoreline feature by using a k-degree B-spline piecewise polynomial curve to obtain the echo image.

In an embodiment, the step (S3) comprises:
(S31) projecting the all-weather two-dimensional image information onto a 3D point cloud data to determine a point cloud range and obtain a first shoreline point cloud, wherein the 3D point cloud data is obtained from a light detection and ranging (LiDAR) sensor;
(S32) extracting a boundary data from the first shoreline point cloud to obtain a second shoreline point cloud; and
(S33) subjecting the tiny feature to matching fusion with the second shoreline point cloud in the same coordinate system to obtain the multi-feature point cloud dataset.

In an embodiment, the step (S32) comprises:
detecting the first shoreline point cloud to obtain a plurality of candidate boundary points;
connecting the plurality of candidate boundary points in sequence to obtain a boundary;
calculating a boundary cost β; evaluating continuity and clarity of the boundary by calculating the number of connection lines in the boundary, a length of each of the connection lines, and an angle between adjacent two of the connection lines; and
optimizing the boundary by using a minimum-cost boundary model based on the boundary cost to obtain the second shoreline point cloud.

In an embodiment, the boundary cost β is calculated according to the following formula:

$$β = D ( {B}_{1} ) + D ( {B}_{2} ) + D ( {B}_{3} ) + D ( {B}_{4} ) + D ( {B}_{5} ) + λ \times ( \vert cos \frac{〈 {B}_{1} , {B}_{2} 〉}{2} \vert + \vert cos \frac{〈 {B}_{1} , {B}_{4} 〉}{2} \vert + \vert cos \frac{〈 {B}_{4} , {B}_{3} 〉}{2} \vert + \vert cos \frac{〈 {B}_{3} , {B}_{5} 〉}{2} \vert + \vert cos \frac{〈 {B}_{2} , {B}_{5} 〉}{2} \vert )$$

wherein λ represents a weight coefficient; Bᵢ represents an i-th connection line, and D (Bᵢ) represents a length of the i-th connection line; N represents a set of adjacent connection lines; <Bᵢ, Bⱼ> represents the angle between the adjacent connection lines; and i, j=1, 2, 3, 4, 5.

In an embodiment, the method comprising:
performing path planning based on the multi-feature point cloud dataset through steps of:
   (A) training a deep reinforcement learning-based marine path planning model using the multi-feature point cloud dataset through steps of:
      evaluating a control effect of an action a predicted by the marine path planning model on a state of the USV using a loss function Lₜₒₜₐₗ; and
      updating parameters of the marine path planning model in each iteration until the action a enables the USV to maintain a required distance from the shoreline, keep a desired speed and avoid surrounding obstacles;
   (B) obtaining a multi-dimensional point cloud data S; wherein the multi-dimensional point cloud data is configured to reflect a current position of the USV, a current speed of the USV, and a relative distance between the USV and each of the surrounding obstacles; and
   obtaining a new state d of the USV and a positive feedback r of the USV based on the multi-dimensional point cloud data S and the multi-feature point cloud dataset;
   (C) inputting the new state d and the positive feedback r into the marine path planning model to predict an optimal navigation action; wherein the optimal navigation action comprises a direction adjustment and a speed adjustment;
   (D) converting, by a decoder, the optimal navigation action into an input command for the USV;
   (E) inputting the input command into a robust adaptive control module of the USV; wherein the robust adaptive control module comprises a sliding mode controller, a course controller and an observer;
   receiving, by the sliding mode controller, a speed change value and a longitudinal disturbance item in the input command to output a longitudinal thrust;
   receiving, by the course controller, the longitudinal thrust and a course change value and a lateral disturbance in the input command to output a rudder deflection angle; and
   estimating, by the observer, the new state of the USV to feed the new state of the USV back to the sliding mode controller and the course controller; and adjusting, by the observer, a feedback gain; and
   (F) repeating steps (B)-(E) to guide the USV to maintain the required distance from the shoreline, keep the desired speed and avoid the surrounding obstacles.

In an embodiment, the step (E) further comprises:
generating, by the sliding mode controller, a corrective action in response to a course error of the USV, wherein the sliding mode controller is expressed as:

$$\dot{u} = \frac{1}{m - {X}_{u}} ( ( m - {Y}_{\dot{v}} ) vr + ( {ml}_{g} - {Y}_{\dot{r}} ) {r}^{2} - ( {Y}_{\dot{p}} + m {𝒽}_{g} ) pr - R ( u ) + {τ}_{cu} + {D}_{1} ( t ) ) ;$$

wherein \dot{u} represents a longitudinal acceleration of the USV, wherein a longitudinal direction is a heading direction of the USV; m represents a weight of the USV; Xᵤ, Y_{\dot{v}}, Y_{\dot{r}}, Y_{\dot{p}} represent hydrodynamic coefficients related to motion of the USV; v represents a lateral speed of the USV; r represents a yaw rate of the USV; l_{g} represents a longitudinal position of a centroid of the USV; h_{g} represents a vertical position of the centroid of the USV; R(u) represents a hydrodynamic resistance of the USV at a forward speed of u; τ_{cu} represents a thrust force in the input command; D₁(t) represents an environment-related disturbance term;

$${τ}_{cu} = - \frac{b}{b - 1} ( {ba}_{1} vr + {ba}_{2} {r}^{2} + {ba}_{3} pr - bR ( u ) - {u}_{d} + b μtanh ( {S}_{d} / α ) ) ,$$

b, a₁, a₂ and a₃ represent control parameters; S_{d}=u−u_{d}, S_{d} represents a difference between the forward speed and the desired longitudinal speed; u_{d} represents a desired longitudinal speed; μ represents an adaptation rate parameter, and is configured to control an update rate of a system parameter; α is a speed weight parameter and configured to weigh system performance; μ and α are design parameters; and p represents a roll rate of the USV.

In an embodiment, the new state of the USV is estimated by the observer according to the following formula:

$$\begin{matrix}\hat{x} = A \hat{x} + {Bry}_{cmd} + {Bu}_{p} + L ( y - C \hat{x} ) ; \\ {u}_{p} = - K \hat{x}\end{matrix}$$

wherein \hat{x} represents an estimated state vector; A represents a matrix describing a dynamic system of the USV; B represents an input matrix describing an influence of the forward speed u on a state of the dynamic system; L represents a gain matrix of the observer; C represents an output matrix that describes a transformation of the state of the dynamic system to an output value; K represents the feedback gain; y_{cmd} represents a commanded heading angle; \hat{\dot{x}} represents is a time derivative of the estimated state vector; and y represents an actual output vector of the dynamic system; and
the feedback gain is adjusted according to the following formula:

$$K = {ΓB}^{T} {P}_{1} {e}_{yl} {x}^{T} ;$$

wherein \dot{K} represents an adjustment change rate of the feedback gain; I′ represents a parameter for adjusting a response rate of the adaptive law; and P₁ represents a positive definite matrix related to a state estimation error.

The present disclosure further provides a shoreline segmentation device, comprising
a memory;
a processor; and
a computer program stored in the memory;
wherein the processor is configured to execute the computer program stored in the memory to implement the method as described above.

By adjusting the feedback gain, the system's response speed and accuracy can be improved. In adaptive control, the adjustment of the feedback gain helps the system adapt more quickly to changing environments or operating conditions. When facing external disturbances or internal parameter changes, the adjustment of the feedback gain can enhance the system's robustness, ensuring good performance even under sub-optimal conditions. Proper adjustment of the feedback gain can reduce system overshoot and oscillation, thereby improving response quality. The adjustment of the feedback gain is a continuous process that dynamically adapts to changes in the system state or environment.

As an inventive concept, this present application also provides a terminal device, which includes a memory, a processor, and a computer program stored in the memory. The processor executes the computer program stored in the memory to implement the steps of the method described in this present application.

Compared with the prior art, the beneficial effects of this present application are as follows. The present application focuses on the effective segmentation and extraction of shoreline information in complex environments. To address issues of weak robustness, limited tiny features of the shoreline and limited depth information of the image captured under a single light source in complex environments, a stacked ensemble shoreline segmentation model is proposed. Further, to address the issue of underactuated USV in complex environments being unable to effectively navigate along a preset route, which results in the shoreline segmentation model failing to achieve its intended results, a control module for distance to the shoreline has been added. A deep reinforcement learning-based marine path planning model is proposed, and commands from this model are converted into USV actions by the demand-controlled ventilation (DCV) robust adaptive control unit, maintaining the USV's distance to the shoreline, an appropriate speed, and timely obstacle avoidance, thereby ensuring the shoreline segmentation model achieves the expected results.

### BRIEF DESCRIPTION OF THE DRAWINGS

FIG. 1 is a flowchart for shoreline perception and segmentation in complex environments according to an embodiment of the present disclosure;

FIG. 2 schematically illustrates the structure of the DMSNet according to an embodiment of the present disclosure;

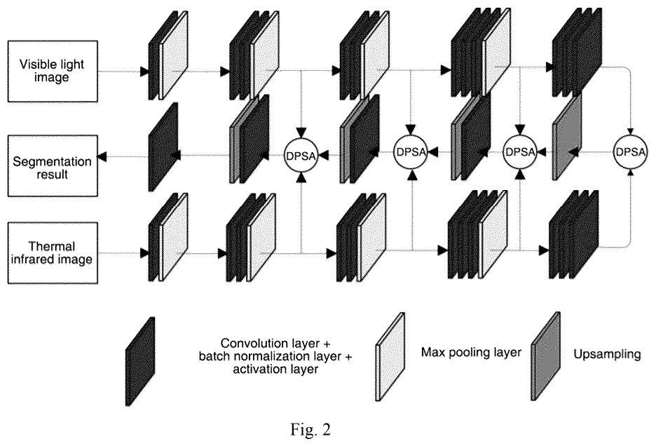

FIG. 3A is a schematic diagram of the original radar image for shoreline feature extraction using a short-wave pulse radar;

FIG. 3B is a schematic diagram of the shoreline contour detection for shoreline feature extraction using the short-wave pulse radar;

FIG. 3C is a schematic diagram of the shoreline parameterization for shoreline feature extraction using the short-wave pulse radar;

FIG. 4A is a schematic diagram of the test algorithm illustration for candidate boundary point extraction;

FIG. 4B is a schematic diagram of the extracted candidate boundary point cloud for candidate boundary point extraction;

FIG. 5A is a schematic diagram of different boundaries generated by candidate points (indices: 1, 2, 3, 4 and 5) for cost calculation for different boundaries;

FIG. 5B is a schematic diagram of connection weights in boundary optimization for cost calculation for different boundaries;

FIG. 6 is a schematic diagram of a minimum-cost boundary model according to an embodiment of the present disclosure;

FIG. 7 is a flowchart of the motion path planning according to an embodiment of the present disclosure; and

FIG. 8 is a flowchart of a dual-loop multi-input robust control according to an embodiment of the present disclosure.

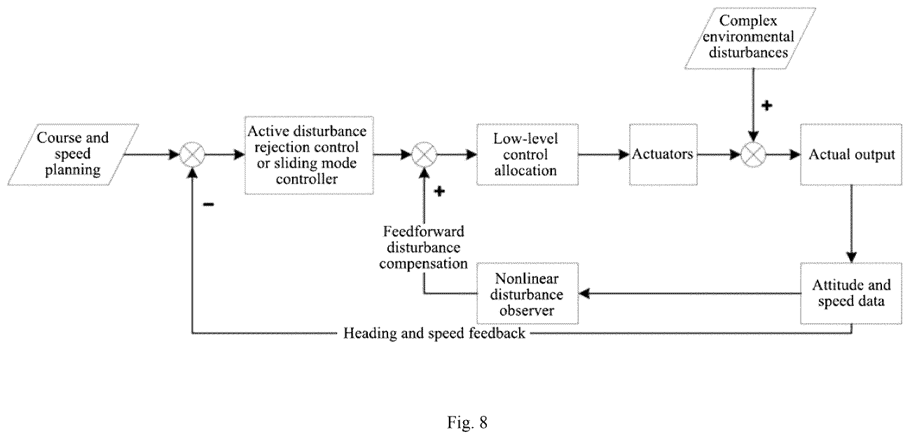

### DETAILED DESCRIPTION OF EMBODIMENTS

The present disclosure has been described in detail above with reference to accompanying drawings and embodiments. It should be noted that the disclosed embodiments are merely exemplary, and are not limited to limit the present disclosure. Those skilled in the art can still make various changes, modifications and replacements to technical features recited in the above embodiments. It should be understood that those changes, modifications and replacements made without departing from the spirit of the disclosure shall fall within the scope of the disclosure defined by the appended claims.

### Embodiment 1

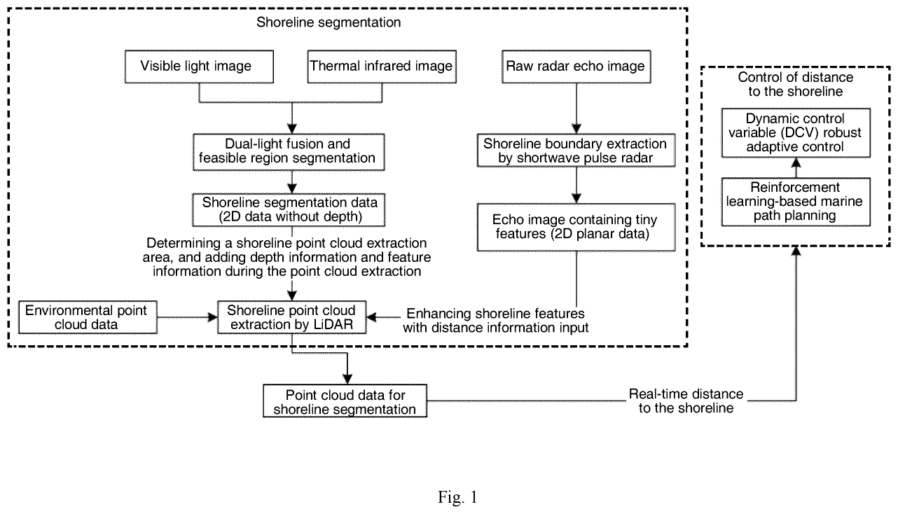

To achieve shoreline segmentation in complex environments based on the perspective of the USV, embodiment 1 of the present application is illustrated in two parts: a stacking ensemble-based shoreline segmentation model and a distance-to-shoreline control module based on deep reinforcement learning and adaptive robust control. The sensors used herein include a red-green-blue (RGB) camera, a thermal infrared camera, a short-wave pulse radar, and LiDAR, as illustrated in FIG. 1.

The specific composition and workflow are as follows.

### (I) Shoreline Segmentation

The shoreline segmentation model consists of three sub-modules: dual-light fusion and feasible region segmentation, shoreline boundary extraction by short-wave pulse radar, and shoreline point cloud extraction by LiDAR. Visible light images and thermal infrared images are captured using an RGB camera and a thermal infrared camera, respectively. The visible light image and the thermal infrared image are subjected to fusion and feasible region segmentation to obtain all-weather two-dimensional image information of the shoreline. Short-wave pulse radar is used to obtain the echo image containing tiny features. The characteristic signal intensity of the tiny features is less than three times the background noise of the tiny features. Both the all-weather two-dimensional image information and the echo image are input into the process of shoreline point cloud extraction by LiDAR to constrain the extraction region and enhance shoreline features. The final output is a multi-feature point cloud dataset for shoreline segmentation.

### (1) Dual-Light Fusion and Feasible Region Segmentation

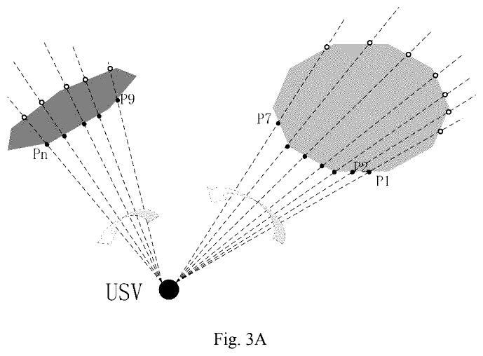

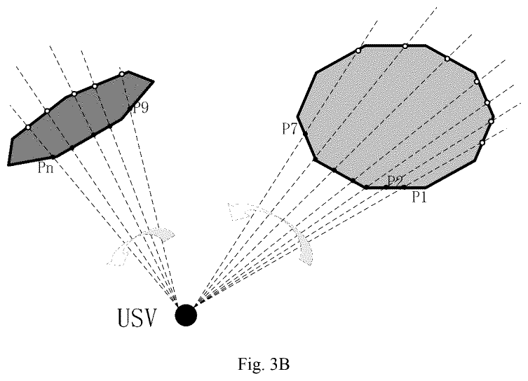

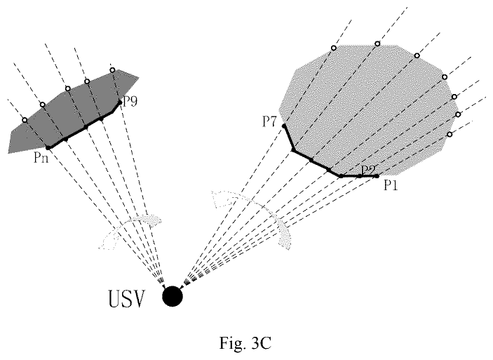

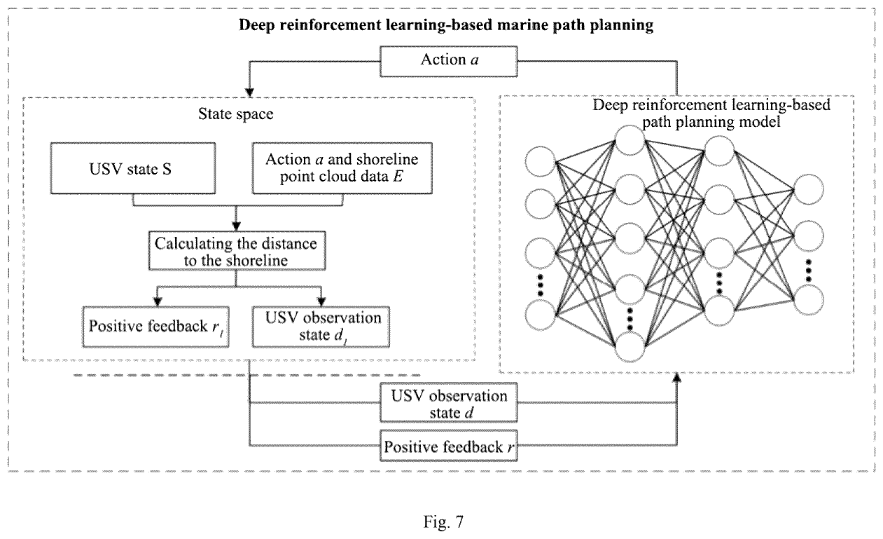

A USV feasible region segmentation model, DMSNet, is employed for visible and thermal infrared image fusion from the perspective of the USV. Extracting feasible regions within the surrounding marine environment is fundamental to achieving autonomous positioning and navigation for the USV on the water surface. Addressing the challenge of all-weather shoreline perception in dark environments, a DMSNet is proposed for the USV under dark environments, based on a visible light camera and an infrared thermal imaging device. The flowchart of the model is shown in FIGS. 3A-7. Further, a lightweight DPFSA module is constructed, which transforms infrared and visible features into the same spatial domain for fusion. This fusion allows the learning of multi-modal features and extraction of low-level details and high-level semantic information from these features, enabling segmentation in complex scenes. This approach minimizes fusion errors caused by differences in feature spaces of different modalities, maintaining strong robustness even under significant lighting changes.

DMSNet primarily consists of an encoder and a decoder. The encoder uses two separate paths to extract features from visible light and thermal infrared images. Each path includes five sets of operations, with each set containing one to three 3×3 convolutional layers followed by batch normalization (BN) layers, which help maintain stable feature distribution within the network. Between each set, a max pooling layer with a stride of 2 reduces the spatial dimensions of the feature maps while increasing the number of convolutional kernels, allowing the encoder to progressively learn richer semantic information from shallow to deep layers. Since DMSNet is a lightweight network designed for the perception of the marine environment, it uses a leaky rectified linear unit (Leaky-ReLU) as the activation function throughout the network. The final output is a segmentation result with the same dimensions as the input image. In the decoder, each set of operations is similar to that of the encoder and contains convolutional layers, batch normalization layers, and activation functions. Between sets of the decoder, a fast upsampling method with a scaling factor of 2 using nearest-neighbor interpolation is applied. Additionally, feature maps of the same dimensions from both the visible light and thermal infrared encoders are fused. To reduce the differences in feature space between the two modalities, the DPFSA module is introduced to automatically transform both modalities into the same space for fusion.

The DPFSA module is designed to perform spatial feature extraction. It retains the feature vectors of data from different modalities and includes pre-adaptation operations and inverse transformation layers. The pre-adaptation operations enhance the model's non-linear capabilities, further applying convolution operations to the transformed data to prevent significant changes in data distribution and improve the model's flexibility. These enhancements allow the shoreline segmentation model to improve its segmentation performance with minimal increase in network parameters.

This module primarily includes two functions: spatial feature extraction (transformation of feature spaces) and fusion of features carrying different information. For spatial feature extraction, a 1×1 convolutional layer with Leaky-ReLU is first used to pre-adapt the thermal infrared features. The pre-adapted thermal infrared features and the visible light features are then input into the transformation network (TransNet) to learn the transformation parameters. Finally, the inverse transformation layer completes the space transformation of the thermal infrared features, as shown in formula (1):

$${f}_{adapt \_ ther} = {G}_{rev} ( α {f}_{pre \_ ther} + β ) ; \qquad ( 1 )$$

In the above formula, α=H_{α}(f_{pre_ther}, fᵥᵢₛ; W_{α}) represents the transformed thermal infrared features; α=H_{α}(f_{pre_ther}, fᵥᵢₛ; W_{α}) represents the operation of the inverse transformation layer, which has the same structure as the pre-adaptation; α=H_{α}(f_{pre_ther}, fᵥᵢₛ; W_{α}) represents the pre-adapted thermal infrared features; α=H_{α}(f_{pre_ther}, fᵥᵢₛ; W_{α}) and α=H_{α}(f_{pre_ther}, fᵥᵢₛ; W_{α}) represent the transformation parameters output by TransNet, calculated by two sub-networks within TransNet as follows:

$$α = {H}_{α} ( {f}_{pre \_ ther} , {f}_{vis} ; {W}_{α} ) ; \qquad ( 2 )$$

$$β = {H}_{β} ( {f}_{pre \_ ther} , {f}_{vis} ; {W}_{β} ) ; \qquad ( 3 )$$

In the above formulas, H_{α} and H_{β} represent the full convolution operations for α and β calculated by the two transformation sub-networks; W_{α} and W_{β} are the corresponding parameters; and fᵥᵢₛ represents the visible light features.

After completing the transformation of feature spaces, the next step is to fuse the features. The transformed thermal infrared features are first concatenated with the visible light features, then element-wise added with the previously fused results to achieve a fusion effect, forming dual-path features. For the first set of data, the initial fusion features are directly obtained by using their own dual-light features (the fusion result of the thermal infrared and visible light features). The process handled by the DPFSA module can be represented as shown in formula (4):

$$DPSA ( V , T ; W ) = {M}_{fuse}^{n} ( {f}_{fuse}^{n + 1} , {f}_{vis}^{n} , {f}_{adapt \_ ther}^{n} ) ; \qquad ( 4 )$$

In this above formula, n is the number of groups in the scene segmentation model; V and T represent the visible light image and the thermal infrared image, respectively; f_{fuse} represents the result after a group of convolution operations in the decoder for the dual-path features output by the DPFSA module; W represents all parameters of this module; and M_{fuse} represents the fusion process through point-by-point addition. As seen in formula (4), the DPFSA module not only retains information from both modalities to form dual-path features but also allows these dual-path features to be processed and then input into the next DPFSA module. This method maximally reduces information mixing and loss, enhancing the utilization of thermal infrared images.

Infrared images from thermal imaging typically have low contrast, with blurred target contours, making it easy for targets to blend with the background and cause misidentifications. By optimizing data augmentation techniques, including horizontal/vertical flipping, rotation/reflection, and random scaling, and by applying contrast-limited histogram equalization for detail enhancement, clearer boundaries and sharper contours of obstacles are achieved. Additionally, a new dataset label format has been introduced, containing directional connectivity information between pixels of the same category. Each category can form an eight-channel directional label map for training, enabling the network to learn the connectivity relationships among similar pixels. This helps mitigate the inaccuracies caused by low contrast and blurred target contours in infrared images, thereby enhancing model prediction accuracy. The output consists of image data, with echo image being a dataset made up of pixels, where each pixel can be represented as q=[x_{q}_{ᵢ},y_{q}_{ᵢ},cₑ_{ᵢ},lₑ_{ᵢ},tᵢ]. (x_{q}_{ᵢ},y_{q}_{ᵢ}) represents the pixel's position in the image, Cₑ_{ᵢ}, is the color vector with three channels corresponding to the red, green, and blue channels in the RGB color model, with values ranging from 0 to 255. lₑ_{ᵢ}; represents the semantic feature of the point cloud, indicating whether the point is land or water; and tᵢ represents a timestamp recording when the point was captured.

### (2) Shoreline Boundary Extraction by Short-Wave Pulse Radar

In the process of extracting and parameterizing shoreline features sensed by the short-wave pulse radar, morphological and bilateral filters are applied to enhance the quality of shoreline images from radar images that commonly contain noise and clutter in ocean environments. A median filter is used to reduce outliers and artifacts in the obtained shoreline features, as illustrated in FIG. 3A. The obtained features are then parameterized using a k-degree B-spline polynomial curve that is segmented, as shown in formula (5):

$$p = {a}_{i = 0}^{{o}^{n}} {c}_{i} {β}_{i , k} ; \qquad ( 5 )$$

In the above formula, p represents the position vector of the spline curve; ci represents the control points; Bik represents the normalized basis functions defined by the Cox-de Boor recursion formula; the equation of feature points in a B-spline curve can be expressed as shown in formula (6):

$${p}_{j} = {β}_{0 , k} ( {t}_{j} ) {c}_{0} + {β}_{1 , k} ( {t}_{j} ) {c}_{1} + ⋯ + {β}_{n , k} ( {t}_{j} ) {c}_{n} \qquad ( 6 )$$

In the above formula, pⱼ represents the j-th feature point obtained from the radar image; tⱼ represents the position along the curve and can be approximated as follows:

$$\begin{matrix}{t}_{0} = 0 \\ {t}_{j} = {a}_{u = 1}^{{o}^{j}} ‖ {p}_{u} - {p}_{u - 1} ‖ , {j}^{3} 1\end{matrix} ; \qquad ( 7 )$$

Given multiple feature points P, a set of control points C can be obtained by fitting these feature points. The least squares fitting equation is expressed as follows:

$$\begin{matrix}C = {[ {B}^{T} B ]}^{- 1} {B}^{T} P \\ B = [ \begin{matrix}{β}_{0 , k} ( {t}_{0} ) & ⋯ & {β}_{n , k} ( {t}_{0} ) \\ ⋮ & ⋱ & ⋮ \\ {β}_{0 , k} ( {t}_{m} ) & ⋯ & {β}_{n , k} ( {t}_{m} )\end{matrix} ]\end{matrix} ; \qquad ( 8 )$$

In the above formula, B represents a configuration matrix with a maximum of k non-zero values per row. A cubic spline curve (k=4) represents the coastline curve, applying a clamped knot vector so that the ends of the spline curve coincide with the first and last control points. An example of coastline parameters obtained using radar images is shown in FIG. 3C. The obtained radar echo image represents each point as g=[x_{g}_{ᵢ},y_{g}_{ᵢ},f_{g}_{ᵢ},tᵢ], (x_{g}_{ᵢ},y_{g}_{ᵢ}) represents the position of the point in the radar echo image, and f_{g}_{ᵢ} represents the signal intensity reflected back to the radar sensor.

### (3) Shoreline Point Cloud Extraction by LiDAR

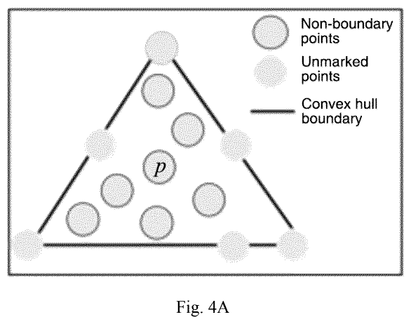

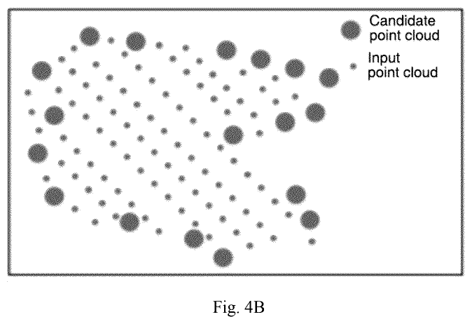

The point cloud p obtained from the LiDAR sensor dataset is represented as P=[xₑ_{ᵢ},yₑ_{ᵢ},zₑ_{ᵢ},fₑ_{ᵢ},tᵢ]. (xₑ_{ᵢ},yₑ_{ᵢ},zₑ_{ᵢ}) represents the spatial coordinates of a point on the shoreline; fₚ_{ᵢ}, represents the reflection intensity of the LiDAR signal at that point. A boundary extraction model can be used by adding constraints to the energy function, allowing adjustment of coefficients or adding new terms to balance based on prior knowledge in different scenarios. The proposed boundary extraction algorithm consists of three steps. Firstly, candidate boundary points are detected from the input point cloud data; next, the boundary cost is calculated through an energy function; then, a minimum-cost boundary model is used to optimize the boundary by minimizing the boundary cost. In the convex hull, if point p lies within the triangle whose vertices are in S, the point p cannot be a boundary point of the convex set S. Thus, boundary points can be determined by removing non-boundary points, as illustrated in FIGS. 4A-4B.

The process begins with the detection of candidate boundary points. During initialization, all point clouds are considered as unmarked points. As shown in FIG. 4A, if a point p is unmarked, its k nearest neighboring points are selected, and the convex hull of (p, pi), is constructed, consisting of a set of points marked as pi, where i=1,2, · · · , k. Then, all points within this convex hull are marked as non-boundary points, and the test is repeated until no more non-boundary points are found. Finally, all unmarked points are considered as candidate boundary points. FIG. 4B shows an example of the extraction algorithm on a simple point cloud.

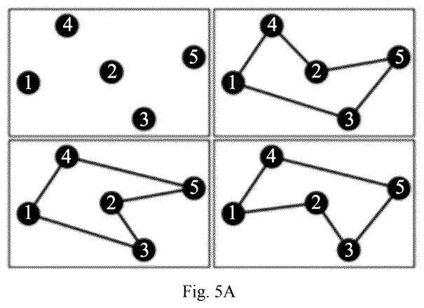

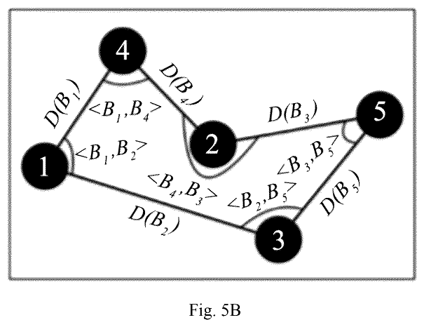

During candidate point extraction, missing points may occur, which is related to the chosen value of neighboring points k. A smaller k can produce more complete boundary points but requires more time for candidate point extraction. Additionally, if a candidate point is too far from other candidate points, exceeding a set threshold Td, it is considered an outlier and will be removed. Due to the point cloud's non-uniform and unordered nature, extracting all boundary points along the shoreline is challenging, because candidate points can generate different boundaries. Assuming there are five candidate boundary points, as shown in the upper left corner of FIG. 5A, this set of candidate boundary points can produce different boundary combinations, as illustrated in the remaining sections of FIG. 5A.

Then, the boundary cost is calculated using the energy function. To evaluate the quality of the shoreline point cloud boundary, the boundary cost β can be defined as follows:

$$β = {\sum }_{i = 1}^{n} ( D ( {B}_{i} ) + {\sum }_{\{ {B}_{i} , {B}_{j} \} ∈ N} λ \times \vert cos ( \frac{〈 {B}_{i} , {B}_{j} 〉}{2} ) \vert ) ; \qquad ( 9 )$$

In the above formula, n represents the number of connections in the boundary, λ is a weight coefficient, Bi represents an i-th connection line, D(Bi) is the length of the i-th connection Bi, and <Bᵢ,Bⱼ> represents the angle between the adjacent connection lines. During boundary optimization, it is desirable for boundary points to be close to each other (D(Bi) is small) and for the angle between adjacent connection lines to be large (cos(<Bᵢ,Bⱼ>/2) is close to 0). FIG. 5B illustrates the weights of all connection lines, and the corresponding boundary value calculation is shown in formula (10):

$$β = D ( {B}_{1} ) + D ( {B}_{2} ) + D ( {B}_{3} ) + D ( {B}_{4} ) + D ( {B}_{5} ) + λ \times ( \vert cos ( \frac{〈 {B}_{1} , {B}_{2} 〉}{2} \vert + \vert cos ( \frac{〈 {B}_{1} , {B}_{4} 〉}{2} \vert + \vert cos ( \frac{〈 {B}_{4} , {B}_{3} 〉}{2} \vert + \vert cos ( \frac{〈 {B}_{3} , {B}_{5} 〉}{2} \vert + \vert cos ( \frac{〈 {B}_{2} , {B}_{5} 〉}{2} \vert ) ; \qquad ( 10 )$$

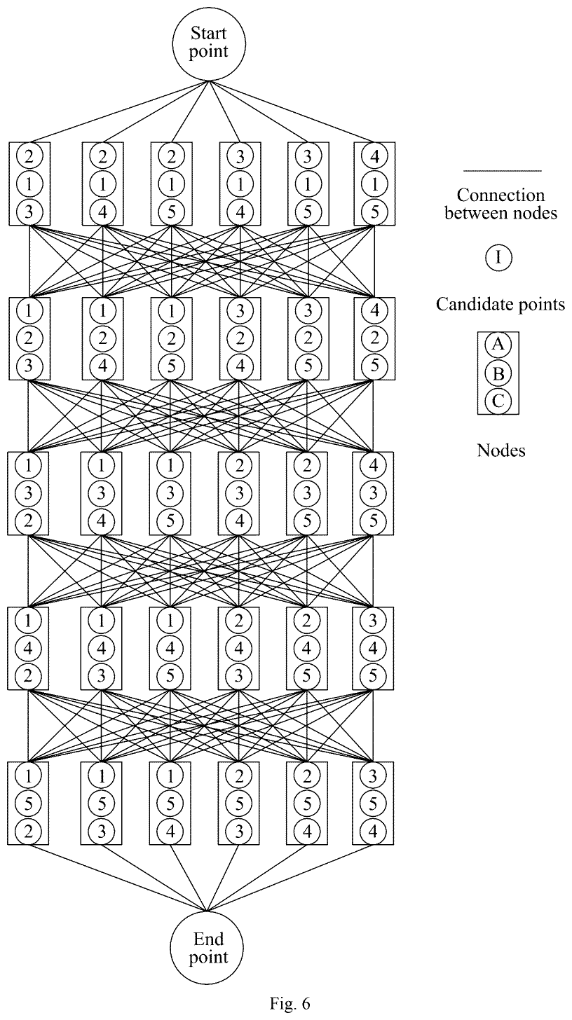

Finally, the boundary is optimized by obtaining the minimum-cost boundary. To obtain a boundary with the minimum β value, a minimum-cost boundary model is used to select the optimal shoreline boundary, as shown in FIG. 6. In this model, a combination of any three points is represented as {LMR}, corresponding to the left, middle, and right candidate points. Taking FIG. 5A as an example, the corresponding nodes are shown in FIG. 6. Each candidate point can be specified as the middle point, so the nodes are divided into five columns. Node {IJK} is equivalent to node {KJI}, where I, J, and K are indices of the candidate points, so the nodes are in a total of 5 rows. Each black circle represents a candidate point, and a combination of three circles represents a node. Each gray line represents a connection line between nodes. In the schematic diagram, Source and Sink nodes are added, and each path from Source to Sink represents a boundary of the input candidate points. The objective of this model is to find a path from the Source node to the Sink node that minimizes the total cost.

$$Minimize {a}_{( i , j ) \hat{I} P}^{o} {β}_{i , j}$$

represents the minimization objective function that requires that the path starts from the Source, passes through a series of nodes, and finally reaches the Sink. Node {IJK} is treated as equivalent to {KJI}, reducing the computational complexity. Thus, the combination in the upper right corner of FIG. 5A corresponds to Source-{314}-{142}-{425}-{253}-{ 531}-Sink and the minimum-cost path is selected as the optimal shoreline boundary.

The shoreline point cloud data E is obtained from q, g, and p, and is represented as E=(xₑ_{ᵢ},yₑ_{ᵢ},zₑ_{ᵢ},cₑ_{ᵢ},fₑ_{ᵢ},lₑ_{ᵢ}) (xₑ_{ᵢ},yₑ_{ᵢ},zₑ_{ᵢ}) represents the spatial coordinates of a point on the shoreline obtained from the shoreline point cloud extraction by LiDAR section; cₑ_{ᵢ} represents the color feature of the point cloud, expressed in RGB values, obtained from the dual-light fusion feasible region segmentation; lei represents the tiny feature of the point cloud, fₑ_{ᵢ} represents the reflection intensity of the point, and fₑ_{ᵢ}=[f_{g}_{ᵢ},fₚ_{ᵢ}].

### (II) Control Distance to Shoreline

The control module for distance to the shoreline is configured to stabilize the speed and distance of the USV from the shoreline in a complex environment, providing an optimal working environment for sensors. It is divided into two steps: deep reinforcement learning-based marine path planning and DCV robust adaptive control. Firstly, the deep reinforcement learning-based marine path planning part gathers distance information between the USV, the shoreline, and obstacles from segmented shoreline point cloud data. The USV's real-time speed and heading are obtained from onboard feedback. By rewarding the maintenance of a preset speed and distance to the shoreline, the system outputs appropriate values for speed and heading adjustments. To implement these route planning instructions on the USV, a DCV robust adaptive controller transforms them into force and torque adjustments for the USV's power system.

### (1) Deep Reinforcement Learning-Based Marine Path Planning

### (i) State Space

The input data includes the shoreline point cloud data E and the data S collected by the sensors onboard the USV, which encompass its current speed, heading, distance to obstacles, ocean current vector speed, and wind vector speed. Through E and S, information such as the distance of the USV to obstacles, its relative distance to the shoreline, current heading, and speed can be obtained.

S=(xₛ_{ᵢ},yₛ_{ᵢ},zₛ_{ᵢ},vₛ_{ᵢ},d_{obstacle}_{ₛᵢ},c_{current}_{ₛᵢ},w_{wind}_{ₛᵢ}), where (xₛ_{ᵢ},yₛ_{ᵢ},zₛ_{ᵢ}) represents the USV's spatial coordinates; vₛ_{ᵢ} represents the USV's vector speed; d_{obstacle}_{ₛᵢ} represents the distance to the nearest obstacle; c_{current}_{ₛᵢ} represents the ocean current vector; and w_{wind}_{ₛᵢ}, represents the wind vector.

The distance between the USV and the closest shoreline point can be calculated from E and S as follows:

$${d}_{USV - to - Shore} = {min}_{i} \sqrt{{( {x}_{{s}_{i}} - {x}_{{e}_{i}} )}^{2} + {( {y}_{{s}_{i}} - {y}_{{e}_{i}} )}^{2} + {( {z}_{{s}_{i}} - {z}_{{e}_{i}} )}^{2}} .$$

d_{USV-to-Shore} represents the distance from USV to the shoreline, the function (minᵢ) is configured to find the minimum Euclidean distance between the USV's position and any point on the shoreline.

In summary, the observation state d can be expressed as:

$$d = ( {d}_{USV - to - Shore} , {v}_{{s}_{i}} , {d}_{{obstacle}_{{s}_{i}}} ) .$$

### (ii) USV Action Execution

The actions performed by the USV in the sea area are represented as a=[wₗ,u_{d}], where w₁ represents the heading adjustment value, indicating the USV's heading change in degrees (positive for right turns, negative for left turns); u_{d} represents the reference speed, representing the target speed for the USV in the upcoming period, measured in knots (positive for acceleration, negative for deceleration). Actions are generated by the agent network and converted into point cloud data representation through a decoder.

### (iii) Reward Function

The reward function is configured to guide the model in learning to make correct navigation decisions, achieving goals like avoiding surrounding obstacles, maintaining an ideal distance from the coastline, and traveling along the optimal path. In the marine path planning based on deep reinforcement learning, the intelligent agent's objectives and motivations (e.g., obstacle avoidance and following the best path) are defined.

When the USV successfully avoids surrounding obstacles and moves toward the target direction, it receives a positive reward. If the USV collides with an obstacle or deviates from the path, it receives a negative reward. The reward function is as follows:

$$r = ( {v}_{{s}_{i}} \cdot cos ( angle ) ) - ( {v}_{{s}_{i}} \cdot sin ( angle ) \cdot sgn ( 0.5 - trackPos ) ) . \qquad ( 11 )$$

In the above formula, angle represents the angle between the USV's travel direction and the tangent of the planned path, and trackPos represents the normalized distance from the USV's centroid to the planned path.

### (iv) Structure of Path Planning Model Network Based on Deep Reinforcement Learning

3D CNN is configured for processing point cloud data and extracting spatial features, and includes the following layers:
Input Layer: Receives and normalizes the point cloud data.
Convolution Layers: First Layer: 32 filters, 3×3×3 kernel size, stride of 1.
Second Layer: 32 filters, 5×5×5 kernel size, stride of 2.
Pooling Layer: Downsampling using a 4×4×4 pooling kernel.
Fully Connected Layers has 256 output units and converts the output into a 1D feature vector needed for the Actor-Critic (AC) network.
Actor Network is configured to generate actions and includes the following layers.
Input Layer: Receives the feature vectors from the 3D CNN. Input size: 25×1.
Fully Connected Layers: First Layer: 64×25, using the Tanh activation function.
Second Layer (Output Layer): 3, using the Tanh activation function. The second layer is configured to generate action decisions for heading angle and speed adjustments.
Critic Network is configured to evaluate action values and includes the following layers.
Input Layer: Receives the same feature vector from the 3D CNN and also the actions generated by the Actor Network. Input size: 25×1.
Fully Connected Layers:
First Layer: 64×25, using the Tanh activation function.
Second Layer (Output Layer): 1, using the Tanh activation function, produces a single value representing the evaluation of the new state and action.
The decoder is configured to convert the action decisions outputted by the Actor Network into control commands understandable by the USV and includes the following layers.
Input Layer: Receives the output from the Actor Network.
Fully Connected Layers: First Layer: 32×12, with the Softmax activation function, converting action decisions into specific control commands.
Second Layer (Output Layer): 3, using the Softmax activation function, generating specific control commands for actual heading angle and speed adjustments.

### (v) Loss Function

The loss function is configured to measure the difference between the model's predictions (predicted action values) and actual observations, guiding the optimization of the path-planning model to better learn and predict which actions will yield the best results.

The overall loss function is the weighted sum of three individual loss functions, as expressed:

$${L}_{total} = {λ}_{actor} \times {L}_{actor} + {λ}_{critic} \times {L}_{critic} + {λ}_{decoder} \times {L}_{decoder} ; \qquad ( 12 )$$

In the above formula, λ_{actor}, λ_{critic}, and λ_{decoder} represent weights used to balance the contributions of each loss component.

Actor Network Loss Function is represented by:

$${L}_{actor} = - E [ log ( π ( a \vert s ) ) \times R ( s , a ) ] ; \qquad ( 13 )$$

In the above formula, L_{actor} represents the loss function of the actor network; E[·] represents the expected value, indicating the average over all possible actions; log(π(a/s)) represents the natural logarithm of the policy probability of action a in state s; π(a/s) represents the policy function, giving the probability of selecting action a in state s; R(s,a) represents the reward obtained by taking action a in state s. This loss function encourages the actor network to increase the probability of high-reward actions and decrease the probability of low-reward actions. A smaller value indicates that the predicted actions are more effective.

Critic Network Loss Function is represented by:

$${L}_{critic} = E [ {( {Q}_{predicted} ( s , a ) - {Q}_{target} ( s , a ) )}^{2} ] ; \qquad ( 14 )$$

L_{critic} represents the loss function of the critic network; Q_{predicted} (s,a) represents the value of taking action a in state s as predicted by the critic network; Q_{target}(s,a) represents the target value, calculated based on the Bellman equation; E[(·)²] represents mean squared error, measuring the gap between the predicted and target values. This loss function optimizes the critic network's ability to estimate action values accurately. A smaller value indicates that the critic network is more precise in estimating action values.

The decoder loss function is represented by:

$${L}_{decoder} = E [ ▯ decoder\_output - target\_command {▯}^{2} ] ; \qquad ( 15 )$$

In the above formula, L_{decoder} represents the loss function of the decoder; decoder_output represents the output of the decoder (the converted action or control command); target_command represents the expected control command or action; E[∥19 ∥²] represents mean squared error, measuring the difference between the decoder's output and the expected command. This loss function ensures that the decoder can accurately convert the actor network's output into executable control commands. By minimizing this loss, the decoder learns to better interpret and convert the actor network's decisions, with a smaller value indicating more accurate conversions.

### (vi) Workflow

Step 1: the USV's state data S is obtained, and the shoreline point cloud data E processed from the shoreline segmentation model is received. Based on S and E, the USV's observation state d and reward function value r are determined. Step 2: d and r are input into the deep reinforcement learning-based marine path planning model. This model, using its internal structure (including 3D CNN and AC network), encodes the data, predicts the optimal navigation actions, and evaluates the predicted best navigation actions. The optimal actions include adjustments in direction and changes in speed. Step 3: the predicted optimal navigation actions are converted into specific instructions that the USV can understand and execute (action a), via the decoder. Step 4: Based on the action a executed by USV, the data in the state space is updated and a new observation state dl and reward function value r1 for the USV are provided. This information is sent back to the path planning model, guiding it in adjusting the prediction of optimal navigation actions.

Through this workflow, the USV maintains an appropriate distance from the shoreline and a certain navigation speed, performing obstacle avoidance maneuvers when necessary.

### (2) USV Robust Adaptive Control

Environmental disturbances such as wind direction and speed, as well as ocean currents and flow speed, are used as inputs along with heading and speed changes from the path planning module, producing outputs for force and moment changes.

### (Step 1) Data Acquisition

The navigation data is obtained using data S and action a, involving variables such as vₛ_{ᵢ}, c_{current}_{ₛᵢ}, w_{wind}_{ₛᵢ}, wₗ and u_{d}.

### (Step 2) Sliding Mode Controller

A sliding mode controller is used to respond to course errors of USV by generating corrective actions to reduce deviation. The controller incorporates environmental disturbance estimations and adjusts the USV's power system to counteract interferences like wind and currents. The adaptive sliding mode controller is formulated as follows:

$$( 16 )$$

$$\dot{u} = \frac{1}{m - {X}_{u}} ( ( m - {Y}_{\dot{v}} ) vr + ( {ml}_{g} - {Y}_{\dot{r}} ) {r}^{2} - ( {Y}_{\dot{p}} + {mh}_{g} ) pr - R ( u ) + {τ}_{cu} + {D}_{1} ( t ) ) .$$

In the above formula, \dot{u} represents a longitudinal acceleration of the USV, where a longitudinal direction is a heading direction of the USV; m represents a weight of the USV; Xᵤ, Y_{\dot{v}}, Y_{\dot{r}}, Y_{\dot{p}} represent hydrodynamic coefficients related to motion of the USV; v represents a lateral speed of the USV; r represents a yaw rate of the USV; l_{g} represents a longitudinal position of a centroid of the USV; h_{g} represents a vertical position of the centroid of the USV; R(u) represents a hydrodynamic resistance of the USV at a forward speed of u; τ_{cu} represents a thrust force in the input command; D₁(t) represents an environment-related disturbance term and is, derived from the longitudinal components of c_{current}_{ₛᵢ}, and w_{wind}_{ₛᵢ}, in S.

The control input with disturbance rejection is as follows:

$${τ}_{cu} = \frac{b}{b - 1} ( {ba}_{1} vr + {ba}_{2} {r}^{2} + {ba}_{3} pr - bR ( u ) - {n}_{d} + b μ tanh ( {S}_{d} / α ) ) . \qquad ( 17 )$$

In the above formula, b, a₁, a₂ and a₃ represent control parameters; S_{d}=u−u_{d};S_{d} represents a difference between the forward speed and the desired longitudinal speed; u_{d} represents a desired longitudinal speed; μrepresents an adaptation rate parameter, and is configured to control an update rate of a system parameter; α is a speed weight parameter and configured to weigh system performance; μ and α are design parameters; and p represents a roll rate of the USV.

### (Step 3) Low-Level Control Allocation

Low-level control allocation is achieved by separating different dynamic characteristics of the USV (such as surge and yaw) and applying specialized control strategies for each. A 4-DOF dynamic maneuvering model is used, which includes surge, sway, yaw, and roll motions. These motions are managed for USV control, particularly under wind disturbances. In this model, surge motion is decoupled from the other degrees of freedom, with adaptive sliding mode control used as a robust controller to estimate unknown parameters and manage the desired longitudinal speed. Additionally, a robust adaptive state feedback controller with an integral term of the output tracking error is employed as a new state variable to track the reference heading angle.

The propulsion system of the USV is adjusted according to the controller output, which involves modifying thrust magnitude and thrust direction. These adjustments are fed back into the USV's propulsion and rudder systems to achieve precise control over heading and speed. Based on the USV's dynamic model and control commands, heading and speed adjustments are executed. The dynamic model includes factors such as the USV's weight, thrust, and rudder angle.

$$\dot{η} = R ( η ) {v}_{{s}_{i}} . \qquad ( 18 )$$

In the above formula, η represents position and orientation vector, indicating the USV's position and orientation in the Earth's coordinate system; vₛ_{ᵢ} represents vector speed, previously mentioned, indicating the vector speed of the USV with respect to its own coordinate system; R(η) represents the Transformation matrix that converts from the USV's own coordinate system to the Earth's coordinate system, and \dot{η} represents vector speed of the USV in the Earth's coordinate system.

Related dynamic equations are represented by:

$$( m - {X}_{u} ) \dot{u} = - ( m - {Y}_{\dot{v}} ) vr + ( - {m}_{lg} ) {\dot{r}}^{2} - {Y}_{\dot{p}} pr + {m}_{hg} \dot{p} r - R ( u ) + {τ}_{cu} + {τ}_{du} \qquad ( 19 )$$

$$( m - {Y}_{\dot{v}} ) \dot{v} + ( m - {Y}_{\dot{r}} ) \dot{r} = {Y}_{v} v + {Y}_{p} p + {Y}_{r} r + {Y}_{ϕ} ϕ - mur + {τ}_{cv} + {τ}_{dv}$$

$${I}_{xx} \dot{p} - ( {m}_{lg} + {N}_{\dot{v}} ) \dot{v} - ( {m}_{hg} + {K}_{\dot{p}} ) \dot{p} = {K}_{v} v + {K}_{p} p + {K}_{r} r + {K}_{ϕ} ϕ - {m}_{GMT} ϕ + {mz}_{g} ur + {τ}_{cp} + {τ}_{dp}$$

$$( {I}_{zz} - {N}_{\dot{r}} ) \dot{r} = {N}_{v} v + {N}_{p} p + {N}_{r} r + {N}_{ϕ} ϕ - {m}_{lg} ur + {τ}_{cr} + {τ}_{dr} .$$

In the above formula, the first equation of formula (19) describes the USV's linear dynamics in the direction of its course; m represents the weight of the USV; X\dot{u}, Y\dot{v}, Y\dot{p} are coefficients related to motion; v, r, p represent speed components; R(u) represents hydrodynamic drag function; τ_{cu}, τ_{du} represent control input terms, indicating the forces along the body's X-axis (longitudinal), affecting the USV's surge motion and the external disturbances respectively. The second equation of formula (19) describes the USV's dynamics in the vertical and rotational directions. Similarly, m presents the weight of the USV; Y_{\dot{v}}, Y_{\dot{r}}, are coefficients related to motion; v, r, p represent speed components; Yᵥ, Yₚ, Yᵣ, Y_{ϕ} represent force and torque coefficients; u represents forward speed; τ_{cv}, τ_{dv} represent control input terms, indicating forces along the body's Y-axis (lateral), influencing the USV's sway motion and external disturbances, respectively. The third equation of formula (19) describes the roll dynamics of the USV. Iₓₓ represents roll inertia of the USV; m_{lg}, m_{hg}, N_{\dot{v}}, K_{\dot{p}} are coefficients related to motion; Kᵥ, Kₚ, Kᵣ, K_{ϕ} represent force and torque coefficients; m_{GMT} represents static stability moment of the roll; z_{g} represents height of the USV's center of gravity; u represents forward speed. τ_{cp}, τ_{dp} represent control input terms, indicating torques, which affect roll and external disturbances, respectively. The fourth equation of the formula (19) describes the yaw dynamics of the USV; l_{zz} represents yaw inertia of the USV; N_{\dot{r}} is Coefficient related to motion; Nᵥ, Nₚ, Nᵣ, N_{ϕ} are force and torque coefficients; m_{1g} is a coefficient related to weight and geometry parameters; u represents forward speed; τ_{cr}, τ_{dr} are control input terms, representing torques, which affect yaw and external disturbances, respectively.

### (Step 4) Actuator System

This step generates control commands for the USV's propulsion and rudder systems. These commands are applied to respond to the planned course and environmental disturbances, maintaining the USV's navigation along the predetermined path.

The course controller uses the current environmental conditions as disturbances and lateral thrust derived from the desired heading angle change and the sliding mode controller's output as rudder control input to calculate the rudder angle change yₚ to adjust the USV's heading:

$$M {\dot{x}}_{p} = {A}_{1} {x}_{p} + {B}_{1} {τ}_{cv} + {d}_{2} ( t ) , \qquad ( 20 )$$

$${y}_{p} = ψ .$$

In the above formula, xₚ represents New state vector, including speed and heading angle; τ_{cv} represents rudder control input, indicating force along the body's Y-axis axis (lateral), affecting the USV's sway motion, calculated as

$$δ {w}_{1} = {tan}^{- 1} ( \frac{{τ}_{cv}}{{τ}_{cu}} )$$

with the angle provided by a; d₂(t) represents environmental disturbance, provided by the lateral components c_{current}_{ₛᵢ} and w_{wind}_{ₛᵢ} from S.

An integrated output tracking error vector calculates the difference between the current and target states, indicating the output tracking error. This error vector reflects the deviation between the actual performance of the USV and its preset targets (e.g., heading angle, position) and is calculated as:

$${e}_{yI} = {y}_{p} - {y}_{cmd} = {C}_{p} {x}_{p} - {y}_{cmd} . \qquad ( 21 )$$

In the above formula, e_{yl} represents integrated output tracking error.

y_{cmd} represents a commanded heading angle, Cₚ represents a transformation matrix.

An observer estimates the USV's new state based on its dynamic model and control inputs:

$$\dot{\hat{x}} = A \hat{x} + {Bry}_{cmd} + {Bu}_{p} + L ( y - C \hat{x} ) \qquad ( 22 )$$

$${u}_{p} = - K \hat{x} ;$$

In the above formula, \hat{x} represents an estimated state vector; A represents system matrix, indicating the USV's intrinsic dynamic behavior in the state without control input; B represents input matrix, describing an influence of the forward speed u; L represents a gain matrix of observer to ensure that the estimated state from the the USV's dynamic system converges to the actual state; C represents output matrix, describing a transformation of the state of the dynamic system to an output value; and K represents feedback gain.

The adjustment of the controller gain is performed according to the output tracking error to reduce the error and enhance controller performance:

$$\dot{K} = Γ {B}^{T} {P}_{1} {e}_{yI} {\hat{x}}^{T} . \qquad ( 23 )$$

In the above formula, \dot{K} represents an adjustment change rate of the feedback gain; Γ represents a parameter for adjusting a response rate of the adaptive law; and P₁ represents a positive definite matrix related to a state estimation error.

### Embodiment 2

This Embodiment 2 of the present disclosure provides a terminal device corresponding to Embodiment 1 above. The terminal device can be a processing device for a client, such as a mobile phone, laptop, tablet, desktop computer, etc., to execute the method in Embodiment 1.

The terminal device in this embodiment includes a memory, a processor, and a computer program stored in the memory. The processor executes the computer program stored in the memory to implement the steps of the method in Embodiment 1. In some implementations, the memory can be high-speed random access memory (RAM) and may also include non-volatile memory, such as at least one disk storage. In other implementations, the processor can be various types of general-purpose processors, such as a central processing unit (CPU) or a digital signal processor (DSP), without limitation here.

### Embodiment 3

This Embodiment 3 of the present disclosure provides a computer-readable storage medium corresponding to Embodiment 1 above, on which a computer program/instructions are stored. When executed by the processor, the computer program/instructions implement the steps of the method in Embodiment 1.

The computer-readable storage medium can be a tangible device that retains and stores instructions used by an instruction execution device. For example, the computer-readable storage medium may include, but is not limited to, electrical storage devices, magnetic storage devices, optical storage devices, electromagnetic storage devices, semiconductor storage devices, or any combination of the above.
Those skilled in the art should understand that the embodiments of this application can be provided as a method, a system, or a computer program product. Therefore, this application can take the form of a fully hardware-based embodiment, a fully software-based embodiment, or an embodiment combining both software and hardware aspects. Moreover, this application may take the form of a computer program product implemented on one or more computer-usable storage media that contain computer-usable program code, including but not limited to magnetic disk storage, CD-ROM, optical storage, etc. The schemes in the embodiments of this application can be implemented in various computer languages, such as object-oriented programming languages like Java and interpreted scripting languages like JavaScript.

This application is described with reference to the flowcharts and/or block diagrams of the methods, devices (systems), and computer program products in the embodiments of this application. It should be understood that each flow and/or block in the flowcharts and/or block diagrams can be implemented by computer program instructions. These computer program instructions can be provided to a processor of a general-purpose computer, special-purpose computer, embedded processor, or other programmable data processing device to create a machine, so that the instructions executed by the computer or other programmable data processing device processor generate devices for implementing the functions specified in one or more flows and/or blocks in the flowchart and/or block diagrams.

These computer program instructions can also be loaded onto a computer or other programmable data processing device, so that a series of operational steps are performed on the computer or other programmable device to provide steps for implementing the functions specified in one or more flows and/or blocks in the flowchart and/or block diagrams.

Described above are merely some preferred embodiments of this application, which are illustrative, and are not intended to limit this application. Though this application has been described in detail above, those skilled in the art can still make various modifications and replacements to the technical solutions recited in the embodiments provided herein. It should be understood that those modifications and replacements made without departing from the spirit of this application shall fall within the scope of this application defined by the appended claims.

What is claimed is:

1. A method for shoreline segmentation in a complex environment based on perspective of an unmanned surface vessel (USV), comprising:
(S1) obtaining a visible light image, a thermal infrared image and a raw radar echo image of a shoreline;
(S2) subjecting the visible light image and the thermal infrared image to fusion and feasible region segmentation to obtain an all-weather two-dimensional image information of the shoreline; and obtaining an echo image of the shoreline based on the raw radar echo image, wherein the echo image comprises a tiny feature with a characteristic signal intensity less than three times a background noise; and
(S3) constraining an extraction region and enhancing shoreline features based on the all-weather two-dimensional image information and the echo image to obtain a multi-feature point cloud dataset for shoreline segmentation.

2. The method of claim 1, wherein in step (S2), the fusion and feasible region segmentation are performed by using a dual modal segmentation network (DMSNet), wherein the DMSNet comprises an encoder, a decoder, and a dual-path feature spatial adaptation (DPFSA) module; and
the fusion and feasible region segmentation are performed through steps of:
extracting, by the encoder, a visible light feature and a thermal infrared feature from the visible light image and the thermal infrared image, respectively;
performing upsampling, by the decoder, on the visible light feature and the thermal infrared feature to obtain an upsampled visible light feature and an upsampled thermal infrared feature;
performing spatial feature extraction, by the DPFSA module, on the upsampled visible light feature and the upsampled thermal infrared feature to obtain a transformed thermal infrared feature and a transformed visible light feature;
fusing, by the DPFSA module, the transformed thermal infrared feature with the transformed visible light feature to obtain a fused feature; and
adding, by the DPFSA module, the fused feature with a previous fused feature point by point to obtain a dual-path feature as the all-weather two-dimensional image information;
wherein for a first set of data, a fused feature from a thermal infrared feature and a visible light feature of the first set of data is used as an initial fused feature.

3. The method of claim 1, wherein the step of obtaining the echo image based on the raw radar echo image comprises:
(S21) obtaining the raw radar echo image by a pulse radar;
(S22) removing, by a median filter, an anomaly and an artifact from the raw radar echo image to obtain an original shoreline feature; and
(S23) parameterizing the original shoreline feature by using a k-degree B-spline piecewise polynomial curve to obtain the echo image.

4. The method of claim 1, wherein the step (S3) comprises:
(S31) projecting the all-weather two-dimensional image information onto a 3D point cloud data to determine a point cloud range and obtain a first shoreline point cloud, wherein the 3D point cloud data is obtained from a light detection and ranging (LiDAR) sensor;
(S32) extracting a boundary data from the first shoreline point cloud to obtain a second shoreline point cloud; and
(S33) subjecting the tiny feature to matching fusion with the second shoreline point cloud in the same coordinate system to obtain the multi-feature point cloud dataset.

5. The method of claim 4, wherein the step (S32) comprises:
detecting the first shoreline point cloud to obtain a plurality of candidate boundary points;
connecting the plurality of candidate boundary points in sequence to obtain a boundary;
calculating a boundary cost β; evaluating continuity and clarity of the boundary by calculating the number of connection lines in the boundary, a length of each of the connection lines, and an angle between adjacent two of the connection lines; and
optimizing the boundary by using a minimum-cost boundary model based on the boundary cost to obtain the second shoreline point cloud.

6. The method of claim 5, wherein the boundary cost β is calculated according to the following formula:
$$β = D ( {B}_{1} ) + D ( {B}_{2} ) + D ( {B}_{3} ) + D ( {B}_{4} ) + D ( {B}_{5} ) + λ \times ( \vert cos \frac{〈 {B}_{1} , {B}_{2} 〉}{2} \vert + \vert cos \frac{〈 {B}_{1} , {B}_{4} 〉}{2} \vert + \vert cos \frac{〈 {B}_{4} , {B}_{3} 〉}{2} \vert + \vert cos \frac{〈 {B}_{3} , {B}_{5} 〉}{2} \vert + \vert cos \frac{〈 {B}_{2} , {B}_{5} 〉}{2} \vert ) ;$$
wherein λ represents a weight coefficient; Bᵢ represents an i-th connection line, and D(Bᵢ) represents a length of the i-th connection line; <Bᵢ, Bⱼ>represents the angle between adjacent connection lines; and i, j=1, 2, 3, 4, 5.

7. The method of claim 1, further comprising:
performing path planning based on the multi-feature point cloud dataset through steps of:
(A) training a deep reinforcement learning-based marine path planning model using the multi-feature point cloud dataset through steps of:
evaluating a control effect of an action a predicted by the marine path planning model on a state of the USV using a loss function Lₜₒₜₐₗ; and
updating parameters of the marine path planning model in each iteration until the action a enables the USV to maintain a required distance from the shoreline, keep a desired speed and avoid surrounding obstacles;
(B) obtaining a multi-dimensional point cloud data S; wherein the multi-dimensional point cloud data is configured to reflect a current position of the USV, a current speed of the USV, and a relative distance between the USV and each of the surrounding obstacles; and
obtaining a new state d of the USV and a positive feedback r of the USV based on the multi-dimensional point cloud data S and the multi-feature point cloud dataset;
(C) inputting the new state d and the positive feedback r into the marine path planning model to predict an optimal navigation action; wherein the optimal navigation action comprises a direction adjustment and a speed adjustment;
(D) converting, by a decoder, the optimal navigation action into an input command for the USV;
(E) inputting the input command into a robust adaptive control module of the USV; wherein the robust adaptive control module comprises a sliding mode controller, a course controller and an observer;
receiving, by the sliding mode controller, a speed change value and a longitudinal disturbance item in the input command to output a longitudinal thrust;
receiving, by the course controller, the longitudinal thrust and a course change value and a lateral disturbance in the input command to output a rudder deflection angle; and
estimating, by the observer, the new state of the USV to feed the new state of the USV back to the sliding mode controller and the course controller; and
adjusting, by the observer, a feedback gain; and
(F) repeating steps (B)-(E) to guide the USV to maintain the required distance from the shoreline, keep the desired speed and avoid the surrounding obstacles.

8. The method of claim 7, wherein the step (E) further comprises:
generating, by the sliding mode controller, a corrective action in response to a course error of the USV, wherein the sliding mode controller is expressed as:
$$\dot{u} = \frac{1}{m - {X}_{u}} ( ( m - {Y}_{\dot{v}} ) vr + ( {ml}_{g} - {Y}_{\dot{r}} ) {r}^{2} - ( {Y}_{\dot{p}} + {mh}_{g} ) pr - R ( u ) + {τ}_{cu} + {D}_{1} ( t ) ) ;$$
wherein u represents a longitudinal acceleration of the USV, wherein a longitudinal direction is a heading direction of the USV; m represents a weight of the USV; Xᵤ, Y\dot{v}, Y\dot{r}, Y\dot{p} represent hydrodynamic coefficients related to motion of the USV; v represents a lateral speed of the USV; r represents a yaw rate of the USV; l_{g} represents a longitudinal position of a centroid of the USV; h_{g} represents a vertical position of the centroid of the USV; R(u) represents a hydrodynamic resistance of the USV at a forward speed of u; τ_{cu} represents a thrust force in the input command; D₁(t) represents an environment-related disturbance term;
$${τ}_{cu} = - \frac{b}{b - 1} ( {ba}_{1} vr + {ba}_{2} {r}^{2} + {ba}_{3} pr - bR ( u ) - {u}_{d} + b μ tanh ( {S}_{d} / α ) ) ,$$
b, a₁, a₂ and a₃ represent control parameters; S_{d}=u−u_{d}, u_{d} represents a desired longitudinal speed, S_{d} represents a difference between the forward speed and the desired longitudinal speed; μ represents an adaptation rate parameter, and is configured to control an update rate of a system parameter; α is a speed weight parameter, and configured to weigh system performance; μ and α are design parameters; and p represents a roll rate of the USV.

9. The method of claim 8, wherein the new state of the USV is estimated by the observer according to the following formula:
$$\dot{\hat{x}} = A \hat{x} + {Bry}_{cmd} + {Bu}_{p} + L ( y - C \hat{x} ) ;$$
$${u}_{p} = - K \hat{x}$$
wherein \hat{x} represents an estimated state vector; A represents a matrix describing a dynamic system of the USV; B represents an input matrix describing an influence of the forward speed u on a state of the dynamic system; L represents a gain matrix of the observer; C represents an output matrix that describes a transformation of the state of the dynamic system to an output value; K represents the feedback gain; y_{cmd} represents a commanded heading angle; \hat{\dot{x}} represents is a time derivative of the estimated state vector; and y represents an actual output vector of the dynamic system; and
the feedback gain is adjusted according to the following formula:
$$\dot{K} = Γ {B}^{T} {P}_{1} {e}_{yI} {\hat{x}}^{T} ;$$
wherein \dot{K} represents an adjustment change rate of the feedback gain; Γ represents a parameter for adjusting a response rate of the adaptive law; and P₁ represents a positive definite matrix related to a state estimation error.

10. A shoreline segmentation device, comprising:
a memory;
a processor; and
a computer program stored in the memory;
wherein the processor is configured to execute the computer program stored in the memory to implement the method of claim 1.
